(19) United States
(12) Patent Application Publication
(10) Pub. No.: US 2014/0200051 A1
(43) Pub. Date: Jul. 17, 2014

(54) RADIO FREQUENCY IDENTIFICATION ON MOBILE COMPUTING DEVICE

(71) Applicant: NVIDIA Corporation, Santa Clara, CA (US)

(72) Inventor: Jingying (Moon) LIU, Shenzhen (CN)

(73) Assignee: NVIDIA Corporation, Santa Clara, CA (US)

(21) Appl. No.: 14/152,952

(22) Filed: Jan. 10, 2014

(30) Foreign Application Priority Data
Jan. 11, 2013 (CN) 201310011747.2

(51) Int. Cl. G06K 7/00; G06K 7/10

(52) U.S. Cl. CPC G06K 7/0008; G06K 7/10009
USPC 455/566; 340/10.1; 340/10.4

(57) ABSTRACT

Method and system for providing radio frequency by using a mobile computing device. A mobile phone comprises a tag antenna and a motherboard integrated with a radio frequency front end module, a processor and a memory. The tag antenna can receive a request carrier signal and transmit an answering carrier signal. The radio frequency front end module can demodulate the request carrier signal to generate a request baseband signal and transfer to the processor, and modulate an answering baseband signal from the processor to generate the answering carrier signal. The processor can decode the request baseband signal to generate request data, and encode answering data to generate the answering baseband signal and transfer the answering baseband signal to the radio frequency front end module. The answering data include the tag data or response data for representing a result of the write operation.

### CROSS-REFERENCE TO RELATED APPLICATIONS

This application claims priority to Chinese Patent Application No. 201310011747.2, filed on Jan. 11, 2013, which is hereby incorporated by reference in its entirety.

### FIELD OF INVENTION

The present invention relates generally to radio frequency identification (RFID), and in particular, RFID applied in mobile computer devices.

### BACKGROUND

RFID technology is a wireless non-contact communication technology. RFID technology uses radio signals to identify particular objects and to read and write relevant data without using mechanical or optical connections between identification systems and the particular objects. RFID technology is characterized as non-contact, fast transmission speed and safety. It is widely used in a variety of fields, such as item identification, data collection, logistics control, electronic payment, identity identification, public transport management, etc. With the development of electronic technology, mobile communication terminals have an increasingly rapid pace of development and smart phones have become the mainstream of the current market. The combination of RFID technology and mobile phones can bring great convenience to people's lives, and therefore has a broad application prospect. Currently the method of combining RFID technology and a mobile computing device is mainly implemented by integrating a RFID module on a Subscriber Identity Module (SIM) card, and therefore the support of telecom operators is typically required.

### SUMMARY OF THE INVENTION

What is needed in the art is technology for realizing the combination of RFID technology and a mobile device having a phone without the support of telecom operators.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

In one embodiment of the present invention, a mobile computing device for RFID is disclosed, including a tag antenna and a mobile computing device motherboard integrated with a radio frequency front end module, a processor and a memory. The mobile device includes a phone. The tag antenna is coupled to the radio frequency front end module, and is operable to receive a request carrier signal from a RFID reader and to transfer the request carrier signal to the radio frequency front end module, and to receive an answering carrier signal from the radio frequency front end module and to transmit the answering carrier signal to the RFID reader. The radio frequency front end module is coupled to the processor, and is operable to demodulate the request carrier signal to generate a request baseband signal and to transfer the request baseband signal to the processor, and to modulate an answering baseband signal from the processor to generate the answering carrier signal and to transfer the answering carrier signal to the tag antenna. The processor is coupled to the memory, and is configured to decode the request baseband signal to generate request data and to perform a read operation or a write operation on the memory based on an instruction included in the request data, and to encode answering data corresponding to the read operation or the write operation to generate the answering baseband signal and to transfer the answering baseband signal to the radio frequency front end module. The memory is operable to store tag data. The answering data may include at least a part of the tag data or response data for representing a result of the write operation.

In an e embodiment of the present invention, the processor is a central processing unit of the mobile computing device. The mobile computing device may comprise a phone circuit.

In an alternative embodiment of the present invention, the central processing unit is further configured to monitor information related to the RFID and to issue a presenting instruction for presenting the information to a screen and/or a speaker of the mobile computing device. The screen and/or the speaker is operable to present the information based on the presenting instruction.

In an alternative embodiment of the present invention, the information may include at least a part of the tag data.

In an alternative embodiment of the present invention, the information includes indication information from the RFID reader which represents that an operation corresponding to the RFID has been completed.

In an alternative embodiment of the present invention, the processor is an additional microprocessor.

In an alternative embodiment of the present invention, the microprocessor is further configured to monitor information related to the RFID and to send the information to a central processing unit of the mobile computing device. The central processing unit is configured to receive the information and to issue a presenting instruction for presenting the information to a screen and/or a speaker of the mobile computing device. The screen and/or the speaker is operable to present the information based on the presenting instruction.

In an alternative embodiment of the present invention, the information includes at least a part of the tag data.

In an alternative embodiment of the present invention, the information may include indication information from the RFID reader which represents that an operation corresponding to the RFID has been completed.

In an alternative embodiment of the present invention, the tag antenna is a mobile computing device antenna within the mobile computing device.

In an alternative embodiment of the present invention, the memory is an inherent memory of the mobile computing device.

In an alternative embodiment of the present invention, the frequency front end module, the processor and the memory are powered by a mobile computing device battery within the mobile computing device.

In an alternative embodiment of the present invention, the radio frequency front end module further includes a power generation circuit for transforming the request carrier signal from the tag antenna to a power signal, and the radio frequency front end module, the processor and the memory are powered by the power generation circuit.

In an alternative embodiment of the present invention, the tag antenna is provided at the top of the mobile computing device.

In another embodiment of the present invention, a method for RFID is also provided. The method includes: receiving a request carrier signal from a RFID reader and transferring the request carrier signal to a radio frequency front end module integrated on a mobile computing device motherboard within a mobile computing device by a tag antenna within the mobile computing device; demodulating the request carrier signal to generate a request baseband signal and transferring the request baseband signal to a processor integrated on the mobile computing device motherboard by the radio frequency front end module; decoding the request baseband signal to generate request data and performing a read operation or a write operation on a memory integrated on the mobile computing device motherboard based on an instruction included in the request data by the processor; encoding answering data corresponding to the read operation or the write operation to generate an answering baseband signal and transferring the answering baseband signal to the radio frequency front end module by the processor; modulating the answering baseband signal to generate an answering carrier signal and transferring the answering carrier signal to the tag antenna by the radio frequency front end module; and receiving the answering carrier signal and transmitting the answering carrier signal to the RFID reader by the tag antenna. The memory is operable to store tag data, and the answering data include at least a part of the tag data or response data for representing a result of the write operation.

In an embodiment of the present invention, the processor is a central processing unit of the mobile computing device, the method further includes: monitoring information related to the RFID and issuing a presenting instruction for presenting the information to a screen and/or a speaker of the mobile computing device by the central processing unit; and presenting the information based on the presenting instruction by the screen and/or the speaker.

In an alternative embodiment of the present invention, the processor is an additional microprocessor, the method further includes: monitoring information related to the RFID and sending the information to a central processing unit of the mobile computing device by the microprocessor; receiving the information and issuing a presenting instruction for presenting the information to a screen and/or a speaker of the mobile computing device by the central processing unit; and presenting the information based on the presenting instruction by the screen and/or the speaker.

In yet another embodiment of the present invention, a system for RFID is also provided. The system includes a RFID reader and a mobile computing device which includes a tag antenna and a mobile computing device motherboard integrated with a radio frequency front end module, a processor and a memory. The RFID reader is operable to transmit a request carrier signal to the mobile computing device and receive an answering carrier signal from the mobile computing device. The tag antenna is coupled to the radio frequency front end module, and is operable to receive the request carrier signal and transfer the request carrier signal to the radio frequency front end module, and receive the answering carrier signal from the radio frequency front end module and transmit the answering carrier signal to the RFID reader. The radio frequency front end module is coupled to the processor, and is operable to demodulate the request carrier signal to generate a request baseband signal and transfer the request baseband signal to the processor, and modulate an answering baseband signal from the processor to generate the answering carrier signal and transfer the answering carrier signal to the tag antenna. The processor is coupled to the memory, and is configured to decode the request baseband signal to generate request data and perform a read operation or a write operation on the memory based on an instruction included in the request data, and encode answering data corresponding to the read operation or the write operation to generate the answering baseband signal and transfer the answering baseband signal to the radio frequency front end module. The memory is operable to store tag data. The answering data include at least a part of the tag data or response data for representing a result of the write operation.

In an alternative embodiment of the present invention, the processor is a central processing unit of the mobile computing device. The central processing unit is further configured to monitor information related to the RFID and issue a presenting instruction for presenting the information to a screen and/or a speaker of the mobile computing device. The screen and/or the speaker is operable to present the information based on the presenting instruction.

In an alternative embodiment of the present invention, the processor is an additional microprocessor. The microprocessor is further configured to monitor information related to the RFID and send the information to a central processing unit of the mobile computing device. The central processing unit is configured to receive the information and issue a presenting instruction for presenting the information to a screen and/or a speaker of the mobile computing device. The screen and/or the speaker is operable to present the information based on the presenting instruction.

The mobile computing device, the method and the system for RFID provided by the present invention may realize the combination of RFID technology and a mobile computing device without the support of telecom operators.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates a block diagram of an exemplary mobile phone for RFID, according to an embodiment of the present invention;

FIG. 2 illustrates a flow chart of an exemplary method for RFID, according to an embodiment of the present invention; and

FIG. 3 illustrates a block diagram of an exemplary system for RFID, according to an embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

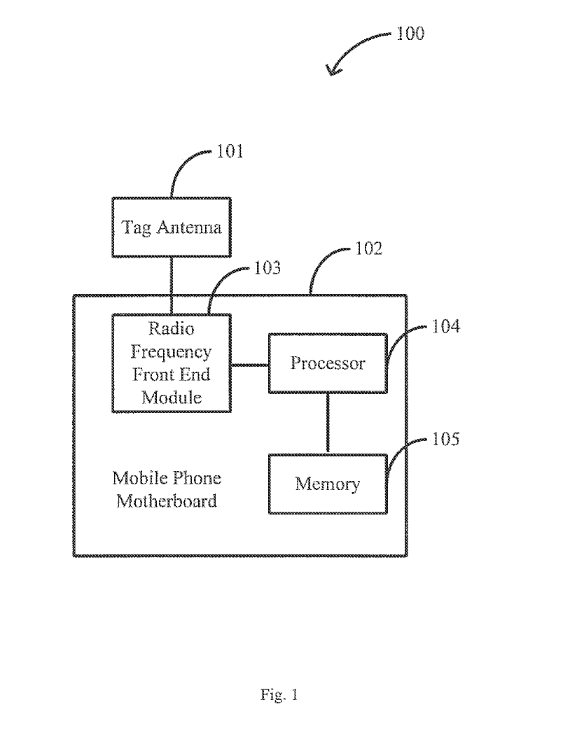

FIG. 1 illustrates a block diagram of an exemplary mobile phone for RFID 100, according to an embodiment of the present invention. As shown in FIG. 1, the mobile phone 100 includes a tag antenna 101 and a mobile phone motherboard 102. There are a radio frequency front end module 103, a processor 104 and a memory 105 integrated on the mobile phone motherboard 102. In one embodiment, two or more of the radio frequency front end module 103, the processor 104 and the memory 105 may be integrated into a chip for easy replacement. In another embodiment, the radio frequency front end module 103, the processor 104 and the memory 105 may be implemented as an individual module respectively.

The tag antenna 101 is coupled to the radio frequency front end module 103, and is operable to receive a request carrier signal from a RFID reader (not shown) and transfer the request carrier signal to the radio frequency front end module 103, and receive an answering carrier signal from the radio frequency front end module 103 and transmit the answering carrier signal to the RFID reader. Tag antennas may be divided into near-field induction coil antennas and far-field radiation antennas based on the RFID operating frequency. The tag antenna 101 may comprise a microstrip antenna, a planar dipole antenna, a loop antenna, etc. Alternatively, the tag antenna may be disposed at the top of the mobile phone 100, so that it is more convenient for the RFID reader to identify the mobile phone 100. In one embodiment, the tag antenna 101 may also be disposed at the side, the bottom and other places of the mobile phone 100. The tag antenna 101 may comprise a mobile phone antenna within the mobile phone 100 or an additional antenna integrated on the mobile phone motherboard 102. Using the mobile phone antenna within the mobile phone 100 as the tag antenna may save space and utilize the powerful emission ability of the mobile phone antenna effectively. It may be beneficial for detection, maintenance and replacement of the tag antenna that the tag antenna 101 is implemented as an additional antenna.

The radio frequency front end module 103 is coupled to the processor 104, and is operable to demodulate the request carrier signal to generate a request baseband signal and transfer the request baseband signal to the processor 104, and modulate an answering baseband signal from the processor 104 to generate the answering carrier signal and transfer the answering carrier signal to the tag antenna 101. The radio frequency front end module 103 may employ any modulation mode known in the art, such as amplitude shift keying (ASK), frequency shift keying (FSK) or phase shift keying (PSK), etc. In one embodiment, the radio frequency front end module 103 may further include a receiving circuit (not shown) and a transmission circuit (not shown). The receiving circuit is operable to demodulate the request carrier signal received by the tag antenna 101 to regain the request baseband signal, and then transfer the request baseband signal to the processor 104 for decoding. The receiving circuit may further include an envelope generation circuit and a detection circuit. The envelope generation circuit is operable to detect the request carrier signal for moving the signal from frequency band to baseband, thereby fetching an envelope of the request baseband signal. In one embodiment, the envelope generation circuit includes a nonlinear element and a low pass filter. The detection circuit includes a band pass filter and a voltage comparator. The detection circuit is operable to filter the carrier wave completely by band pass filtering to smooth the signal curve. Then the filtered signal passes through the voltage comparator to regain the request baseband signal. The transmission circuit may be operable to modulate the answering baseband signal encoded by the processor 104, for example ASK modulating, and to amplify the answering baseband signal to generate the answering carrier signal. Then the transmission circuit transfers the answering carrier signal to the tag antenna 101.

The radio frequency front end module 103 may also include a power generation circuit, which is operable to convert the request carrier signal from the tag antenna to a power signal for powering the radio frequency front end module 103, the processor 104 and the memory 105. In one embodiment, the power generation circuit is operable to convert alternating current received by the tag antenna 101 to direct current applying to RFID related modules. The power generation circuit may include a rectifier circuit, a filter circuit, a voltage stabilizing circuit and a limiter circuit, etc. The power generation circuit may gain energy from the request carrier signal to power RFID related modules. Therefore a mobile phone configured with the power generation circuit uses little power to power the RFID and the battery thereof has a longer life.

Alternatively, the radio frequency front end module 103 may also include a reset signal generation circuit and/or a clock generation circuit. The reset signal generation circuit may be operable to generate a power on reset signal and a power down reset signal. The poweron reset signal may set initial values for digital circuits of RFID related modules to avoid logical confusion. The power on reset signal may also provide stable time for RFID related modules to ensure that energy coupled on both sides of the tag antenna 101 has been relatively stable. The power down reset signal may protect RFID related modules when unexpected situations arise, for example, no electricity suddenly in operation. The clock generation circuit may further include a shaping circuit and a frequency divider. The clock generation circuit may use the request carrier signal to generate clock signals required by digital circuits of RFID related modules.

The processor 104 is coupled to the memory 105, and is configured to decode the request baseband signal to generate request data and perform a read operation or a write operation on the memory 105 based on an instruction included in the request data, and encode answering data corresponding to the read operation or the write operation to generate the answering baseband signal and transfer the answering baseband signal to the radio frequency front end module 103. When the instruction included in the request carrier signal is a read instruction, the processor 104 can perform a read operation on the memory 105 to read at least a part of the tag data, such as a unique identifier of the tag, stored in the memory 105. The at least a part of the tag data are sent to the RFID reader after being encoded and modulated. In this situation the answering data are the at least a part of the tag data. When the instruction included in the request carrier signal sent by the RDIF reader is a write instruction, the processor 104 performs a write operation on the memory 105 to write data into the memory 105 based on the write instruction. In this situation the answering data are response data for representing a result of the write operation, such as a write complete indicator or a write failure indicator. In one embodiment, the processor 104 may perform functions of encryption and anti-collision algorithm.

The memory 105 is operable to store the tag data. The memory 105 may be selected from serial E²PROM, PROM or FRAM, so that the RFID reader may not only read the tag data, but also write relevant information into the mobile phone. For example, the memory 105 may be 32 bit E²PROM. According to an embodiment of the present invention, the memory 105 may be an inherent memory of the mobile phone 100 or an additional memory. The memory 105 is implemented as the inherent memory of the mobile phone, so that the tag data may be stored in the inherent memory. The inherent memory of the mobile phone has large storage capacity and is convenient for the central processing unit to manage the tag data. It is beneficial for replacement of the memory that the memory 105 is implemented as an additional memory. The above tag data may include identity identification information, location information or specific information about the tagged product, such as price, color, date of purchase, etc.

A tag antenna, a radio frequency front end module, a processor and a memory are integrated in the mobile phone provided by the present invention, which may make the mobile phone become a universal electronic tag. The advantage of this technology is that it is convenient and can be unlimited by telecom operators. Moreover, since there is no contact between RFID related modules within the mobile phone and the RFID reader, there is less wear and tear of RFID related modules and less maintain required. It is beneficial for RFID related modules to communicate with other components or modules on the mobile phone motherboard that multiple RFID related modules are integrated on the mobile phone motherboard.

According to an embodiment of the present invention, the processor 104 may be a central processing unit of the mobile phone 100. The RFID process may be controlled by the central processing unit of the mobile phone 100 directly. That is, the central processing unit may control a read operation or a write operation on the memory 105 based on the instruction included in the request data and return the answering baseband signal to the radio frequency front end module 103. The central processing unit has stronger computing power and a higher processing speed. It may better utilize the main system of the mobile phone in RFID that the central processing unit is used as the processor for RFID.

The central processing unit may further be configured to monitor information related to the RFID and issue a presenting instruction for presenting the information to a screen and/or a speaker (not shown) of the mobile phone. The screen and/or the speaker may be operable to present the information based on the presenting instruction. It is convenient for users to review RFID related information that the information is presented on the mobile phone.

The information may include at least a part of the tag data. For example, the central processing unit may monitor the changes of the tag data in the memory 105 during performing a write operation on the memory. The central processing unit may send a presenting instruction to the screen and/or the speaker for transferring at least a part of the tag data to the screen and/or the speaker when the tag data change, thereby displaying at least a part of the tag data on the screen or showing them as voice through the speaker. In an embodiment, the mobile phone 100 can be used as a bus card and the tag data include the current amount of money in the card. The credit card machine of the public transport system is a RFID reader. When users use the mobile phone 100 to swipe card, the credit card machine can subtract a certain value from the current amount of money after reading out the current amount of money in the mobile phone 100. Then the credit card machine writes a new amount of money into the mobile phone 100. When the new amount of money is written into the mobile phone 100, the central processing unit monitors the changes in the current amount of money. The central processing unit may issue a presenting instruction for presenting the changes to the screen and/or the speaker of the mobile phone. The screen and/or the speaker may present the amount of money before and after the changes base on the presenting instruction.

The information may also include indication information from the RFID reader which represents that an operation corresponding to the RFID has been completed. When the RFID reader returns an indication signal for indicating that the RFID has been completed, the central processing unit may also control the screen and/or the speaker to present the information, so that the user is informed. In an embodiment, the mobile phone 100 may be used as an electronic key of a parking lot management system. The RFID reader of the parking lot restores an answering carrier signal transmitted by the mobile phone 100 back to answering data after receiving the answering carrier signal. The answering data may include the user's identity information. Then the RFID reader sends the answering data to a background computer system for being further processed. The background computer system utilizes the answering data to complete the authentication for the user's identity. After confirming the user's identity, the background computer system informs the electronic access control of the parking lot of allowing the user to enter the parking lot. Then the background computer system informs the RFID reader that the authentication for the user's identity has been completed. The RFID reader transmits indication information for representing that the authentication for the user's identity has been completed to the mobile phone 100. The indication information is transmitted in a form of a radio frequency signal. The mobile phone 100 restores the indication information and controls the screen and/or the speaker of the mobile phone 100 to present the information.

According to another embodiment, the processor 104 may be an additional microprocessor. The microprocessor takes part in RFID process directly, that is it may control a read operation or a write operation on the memory 105 based on the instruction included in the request data and return the answering baseband signal to the radio frequency front end module 103. The additional microprocessor may be, such as a universal low power microprocessor 89LV51. The microprocessor may communicate with the radio frequency front end module 103 through a Serial Peripheral Interface (SPI). The SPI interface does not need an addressing operation and is used for full-duplex communication, thus using the SPI interface is easy and efficient. The additional microprocessor may be designed to be only used for RFID, which is easy to be implemented.

Alternately, the microprocessor and the central processing unit may communicate with each other. The microprocessor may further be configured to monitor information related to the RFID and send the information to the central processing unit of the mobile phone. The central processing unit may be configured to receive the information and issue a presenting instruction for presenting the information to a screen and/or a speaker of the mobile phone. The screen and/or the speaker may be operable to present the information based on the presenting instruction. Similarly to the above description, the information may include at least a part of the tag data. The information may also include indication information from the RFID reader which represents that an operation corresponding to the RFID has been completed.

According to an embodiment of the present invention, the frequency front end module 103, the processor 104 and the memory 105 may be powered by a mobile phone battery (not shown) within the mobile phone. The mobile phone battery may be a lithium battery or a Nickel-Metal hydride battery. Those skilled in the art will realize that the central processing unit can control the mobile phone battery to power the frequency front end module 103, the processor 104 and the memory 105 through hardware and/or software design. Such mobile phone may be used as a semi-passive tag or an active tag, which may be identified from a distance, in higher identification speed and be more stable compared to a passive tag.

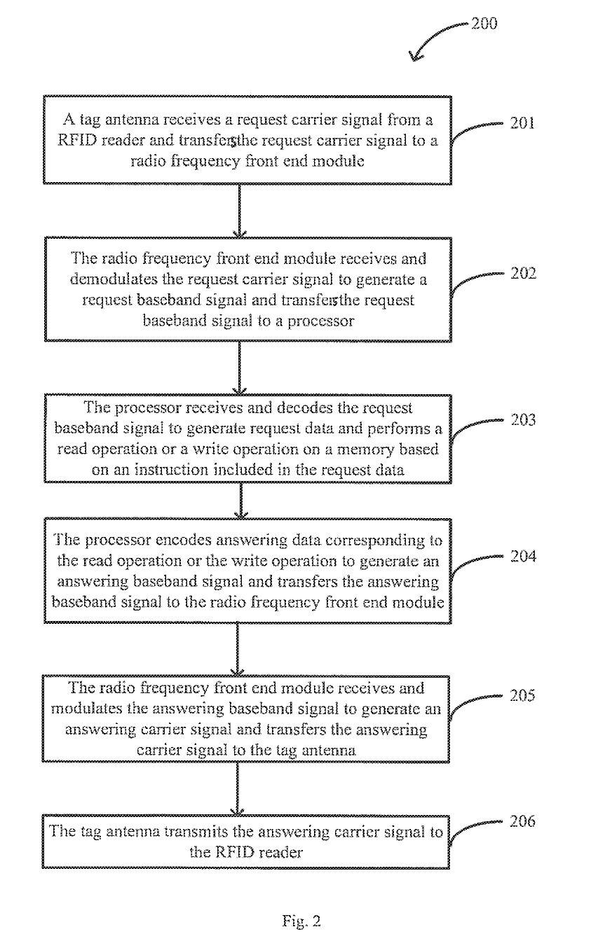

In another aspect of the present invention, a method for RFID is also provided. FIG. 2 illustrates a flow chart of an exemplary method for RFID 200, according to an embodiment of the present invention. Now the steps of the method 200 are described in conjunction with FIG. 1 and FIG. 2. At step 201, a request carrier signal from a RFID reader is received and transferred to a radio frequency front end module 103 integrated on a mobile phone motherboard within a mobile phone 100 by a tag antenna 101 within the mobile phone 100. At step 202, the request carrier signal is demodulated to generate a request baseband signal and the request baseband signal is transferred to a processor 104 integrated on the mobile phone motherboard by the radio frequency front end module 103. At step 203, the request baseband signal is decoded to generate request data and a read operation or a write operation is performed on a memory 105 integrated on the mobile phone motherboard based on an instruction included in the request data by the processor 104. The memory 105 is operable to store tag data. At step 204, answering data corresponding to the read operation or the write operation are encoded to generate an answering baseband signal and the answering baseband signal is transferred to the radio frequency front end module 103 by the processor 104. The answering data include at least a part of the tag data or response data for representing a result of the write operation. At step 205, the answering baseband signal is modulated to generate an answering carrier signal and the answering carrier signal is transferred to the tag antenna 101 by the radio frequency front end module 103. At step 206, the answering carrier signal is received and transmitted to the RFID reader by the tag antenna 101.

The tag antenna, the radio frequency front end module, the processor and the memory involved in the above method for RFID have been described in the description about embodiments of the mobile phone for RFID. For brevity, a detailed description thereof is omitted. Those skilled in the art can understand that specific structure and operation mode thereof with reference to FIG. 1 and FIG. 2 in combination with the above description.

According to an embodiment of the present invention, the processor 104 is a central processing unit of the mobile phone 100, the method 200 further includes monitoring information related to the RFID and issuing a presenting instruction for presenting the information to a screen and/or a speaker of the mobile phone 100 by the central processing unit. The method 200 further includes presenting the information based on the presenting instruction by the screen and/or the speaker.

According to another embodiment of the present invention, the processor 104 is an additional microprocessor. The method 200 further includes the following steps. Information related to the RFID is monitored and sent to a central processing unit of the mobile phone 100 by the microprocessor. The information is received by the central processing unit and a presenting instruction for presenting the information is issued to a screen and/or a speaker of the mobile phone 100 by the central processing unit. Then the information is presented based on the presenting instruction by the screen and/or the speaker.

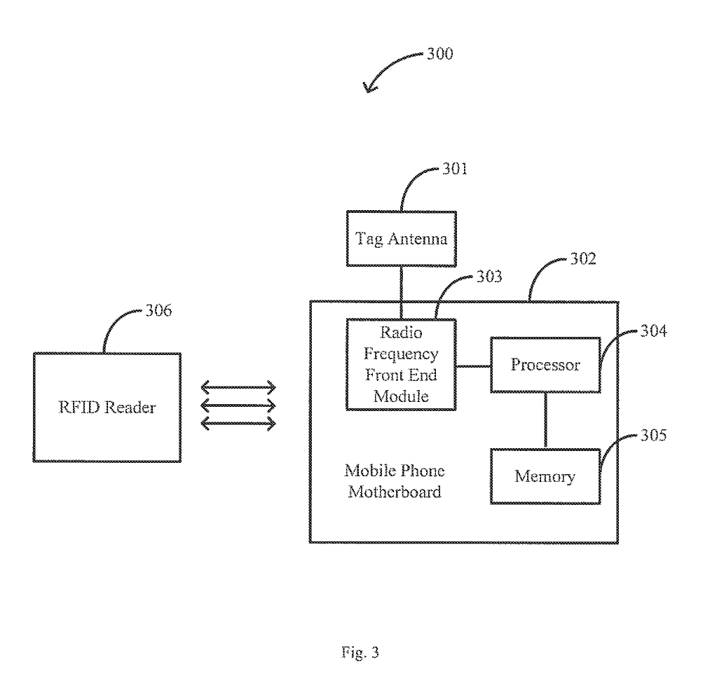

In yet another aspect of the present invention, a system for RFID is also provided. FIG. 3 illustrates a schematic block diagram of a system for RFID 300, according to an embodiment of the present invention. The system 300 includes a RFID reader 306 and a mobile phone. The mobile phone includes a tag antenna 301 and a mobile phone motherboard 302. The mobile phone motherboard 302 is integrated with a radio frequency front end module 303, a processor 304 and a memory 305. The RFID reader 306 is operable to transmit a request carrier signal to the mobile phone and receive an answering carrier signal from the mobile phone. The RFID reader 306 may include a control unit, a reader antenna and a radio frequency module comprising a transmitter and a receiver. The RFID reader 306 may communicate with the mobile phone through the reader antenna. When the RFID reader 306 is in operation, the control unit can generate request data needed to be sent to the mobile phone and encodes the request data to generate a request baseband signal. The transmitter can convert the request baseband signal to a request carrier signal in order to transmit the request carrier signal via the reader antenna. The request carrier signal may be a radio frequency signal.

When the mobile phone receives the request carrier signal, it can generate a corresponding answering carrier signal. The answering carrier signal can be received and demodulated to generate an answering baseband signal by the receiver. Then the receiver can transfer the answering baseband signal to the control unit. The control unit can decode the answering baseband signal to generate answering data. The RFID reader 306 may further process the answering data to complete the RFID. When the RFID is completed, the RFID reader 306 may generate indication information which represents that an operation corresponding to the RFID has been completed and send the indication information to the mobile phone. The mobile phone may present the indication information. Alternatively, the RFID reader 306 may be coupled to a background control system, such as a computer system, etc. The RFID reader 306 may transfer the answering data to the background control system for further processing. For example, the background control system may identify the identity of the user according to the answering data and give the user permission, etc.

The tag antenna, the radio frequency front end module, the processor and the memory involved in the above system for RFID have been described in the description about embodiments of the mobile phone for RFID. For brevity, a detailed description thereof is omitted. Those skilled in the art can understand that specific structure and operation mode thereof with reference to FIG. 1 and FIG. 2 in combination with the above description.

The above mobile phone, method and system for RFID may employ the following operating frequency: low frequency 100-500 KHz, high frequency 10-15 MHz, ultrahigh frequency 850-960 MHz, microwave frequency band 2.45 GHz and 5.8 GHz. It is preferable for the operating frequency to be 13.56 MHz. The system with 13.56 MHz may provide a relatively far identification distance and be widely used. The above mobile phone, method and system for RFID may be used for access control, electronic payment, public transport system or parking management system, etc.

According to an embodiment of the present invention, the system for RFID may be used for a parking management system. In the embodiment, the RFID reader is provided in the parking entrance and/or the parking export, which is connected with a background computer system. The identification range of the RFID reader includes at least the region between the parking entrance and the parking export. When the user carrying a mobile phone for RFID enters this identification range, the RFID reader can transmits a request carrier signal to the mobile phone to instruct the mobile phone to perform identity identification. The mobile phone can encode and modulate the user's identity information stored in the mobile phone and return the identity information to the RFID reader after receiving the request carrier signal. The RFID reader can restore the user's identity information by demodulation and decoding, and then transfer the user's identity information to the background computer system. The background computer system can retrieve a database to verify the user's identity. After the user's identity has been confirmed, the background computer system can inform the electronic access control of allowing the user to enter the parking lot. Such a parking management system may identify the vehicle and its owner's identity rapidly and accurately, making the management of the parking lot more humane, intelligent and efficient. Those skilled in the art will realize that such a management system may be used for other access control system.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A mobile computing device operable for radio frequency identification, the mobile computing device comprising:
a processor;
a memory coupled to the processor;
a tag antenna; and
a radio frequency front end module disposed on an integrated circuit board and coupled to the processor and the tag antenna,
wherein the tag antenna is operable to receive a request carrier signal from a radio frequency identification reader and transfer the request carrier signal to the radio frequency front end module.

2. The mobile computing device of claim 1,
wherein the tag antenna is further operable to receive an answering carrier signal from the radio frequency front end module and transmit the answering carrier signal to the radio frequency identification reader,
wherein the radio frequency front end module is operable to:
demodulate the request carrier signal to generate a request baseband signal and transfer the request baseband signal to the processor; and
modulate an answering baseband signal from the processor to generate the answering carrier signal and transfer the answering carrier signal to the tag antenna;
wherein the processor is configured to:
decode the request baseband signal to generate request data and perform a read operation or a write operation on the memory based on an instruction included in the request data; and
encode answering data corresponding to the read operation or the write operation to generate the answering baseband signal and transfer the answering baseband signal to the radio frequency front end module;
wherein the memory is operable to store tag data; and
wherein the answering data include at least a part of the tag data or response data for representing a result of the write operation.

3. The mobile computing device of claim 2 further comprising a display screen, a speaker, and a phone circuit, wherein the processor is a central processing unit of the mobile computing device, wherein the central processing unit is configured to monitor information related to radio frequency identification and issue a presenting instruction for presenting the information to the display screen and/or the speaker of the mobile phone.

4. The mobile computing device of claim 3, wherein the information includes at least a part of the tag data.

5. The mobile computing device of claim 3, wherein the information comprises an indication from the radio frequency identification reader, the indication representing that an operation with respect to the radio frequency identification has been completed.

6. The mobile computing device of claim 1 further comprising a central processing unit, wherein the processor is a microprocessor additional to the central processing unit of the mobile computing device, and wherein the mobile computing device is a mobile phone.

7. The mobile computing device of claim 6, wherein
the microprocessor is further configured to monitor information related to the radio frequency identification and send the information to the central processing unit of the mobile phone; and
the central processing unit is configured to receive the information and issue a presenting instruction for presenting the information to a display screen and/or a speaker of the mobile phone.

8. The mobile device of claim 7, wherein the information comprises at least a part of the tag data.

9. The mobile device of claim 7, wherein the information comprises s an indication from the radio frequency identification reader which represents completion of an operation corresponding to the radio frequency identification.

10. The mobile computing device of claim 1, wherein the tag antenna is an antenna enclosed in a housing of the mobile computing device.

11. The mobile device of claim 1, wherein the memory is an inherent memory of the mobile computing device.

12. The mobile device of claim 1 further comprising a battery, and wherein the radio frequency front end module, the processor and the memory are powered by the battery.

13. The mobile device of claim 1, wherein the radio frequency front end module further comprises a power generation circuit configured to transform the request carrier signal from the tag antenna to a power signal, and the radio frequency front end module, wherein the processor and the memory are powered by the power generation circuit.

14. The mobile device of claim 1, wherein the tag antenna is disposed at one end of the mobile computing device.

15. A method for radio frequency identification including:
receiving a request carrier signal from a radio frequency identification reader;
transferring the request carrier signal to a radio frequency front end module integrated on a mobile computing device integrated circuit board within a mobile computing device by a tag antenna integrated with the mobile computing device, wherein the mobile computing device comprises a phone circuit;
demodulating the request carrier signal to generate a request baseband signal and transferring the request baseband signal to a processor integrated on the integrated circuit board by the radio frequency front end module;
decoding the request baseband signal to generate request data;
performing a read operation or a write operation on a memory integrated on the integrated circuit board based on an instruction included in the request data;
encoding answering data corresponding to the read operation or the write operation to generate an answering baseband signal and transferring the answering baseband signal to the radio frequency front end module;
modulating the answering baseband signal to generate an answering carrier signal and transferring the answering carrier signal to the tag antenna by the radio frequency front end module; and
receiving the answering carrier signal and transmitting the answering carrier signal to the radio frequency identification reader by the tag antenna;
wherein the memory is operable to store tag data, and the answering data comprise at least a part of the tag data or response data that represent a result of the write operation.

16. The method of claim 15, wherein the processor is a central processing unit of the mobile computing device, the method further includes:
monitoring information related to the radio frequency identification;
issuing a presenting instruction for presenting the information to a screen and/or a speaker of the mobile computing device by the central processing unit; and
presenting the information based on the presenting instruction by the screen and/or the speaker.

17. The method of claim 15, wherein the processor is a microprocessor additional to a central processing unit of the mobile computing device, the method further includes:
monitoring information related to the radio frequency identification and sending the information to the central processing unit of the mobile computing device by the microprocessor;
receiving the information and issuing a presenting instruction for presenting the information to a screen and/or a speaker of the mobile computing device by the central processing unit; and
presenting the information based on the presenting instruction by the screen and/or the speaker.

18. A system for radio frequency identification comprising a radio frequency identification reader and a mobile computing device which comprises a tag antenna and a mobile computing device integrated circuit board integrated with a radio frequency front end module, a processor and a memory,
wherein the radio frequency identification reader is operable to transmit a request carrier signal to the mobile computing device and receive an answering carrier signal from the mobile computing device;
wherein the tag antenna is coupled to the radio frequency front end module, and is operable to receive the request carrier signal and transfer the request carrier signal to the radio frequency front end module, and receive the answering carrier signal from the radio frequency front end module and transmit the answering carrier signal to the radio frequency identification reader;
wherein the radio frequency front end module is coupled to the processor, and is operable to demodulate the request carrier signal to generate a request baseband signal and transfer the request baseband signal to the processor, and modulate an answering baseband signal from the processor to generate the answering carrier signal and transfer the answering carrier signal to the tag antenna;
wherein the processor is coupled to the memory, and is configured to decode the request baseband signal to generate request data and perform a read operation or a write operation on the memory based on an instruction included in the request data, and encode answering data corresponding to the read operation or the write operation to generate the answering baseband signal and transfer the answering baseband signal to the radio frequency front end module;
wherein the memory is operable to store tag data; and
wherein the answering data include at least a part of the tag data or response data for representing a result of the write operation.

19. The system of claim 18, wherein the processor is a central processing unit of the mobile computing device, wherein the central processing unit is further configured to monitor information related to the radio frequency identification and issue a presenting instruction for presenting the information to a screen and/or a speaker of the mobile computing device.

20. The system of claim 18, wherein the processor is an additional microprocessor,
wherein the microprocessor is further configured to monitor information related to the radio frequency identification and send the information to a central processing unit of the mobile computing device; and
wherein the central processing unit is configured to receive the information and issue a presenting instruction for presenting the information to a screen and/or a speaker of the mobile computing device.
